(19) United States
(12) Patent Application Publication
(10) Pub. No.: US 2025/0361705 A1
(43) Pub. Date: Nov. 27, 2025

(54) ELECTRONIC PLUMBING SYSTEM INCLUDING GESTURE CONTROL

(71) Applicant: Fortune Brands Water Innovations LLC, North Olmsted, OH (US)

(72) Inventors: Robert J. Kinicki, Parma, OH (US); George John Polly, Brecksville, OH (US); Brian Patrick Frackelton, Macedonia, OH (US)

(21) Appl. No.: 19/227,006

(22) Filed: Jun. 3, 2025

Related U.S. Application Data
(63) Continuation of application No. 17/702,369, filed on Mar. 23, 2022.
(60) Provisional application No. 63/165,070, filed on Mar. 23, 2021.
(60) Provisional application No. 63/242,481, filed on Sep. 9, 2021.

(51) Int. Cl. E03C 1/05; G06F 3/01; G06F 3/16

(52) U.S. Cl. CPC E03C 1/057; G06F 3/017; G06F 3/167

(57) ABSTRACT

The present invention provides an electronic plumbing system including gesture control. The electronic plumbing system includes a user input/output module. The user input/output module includes an activation sensor. The activation sensor is operable to be mounted on the electronic plumbing system. The activation sensor is operable to define an activation zone. The activation sensor is operable to detect a gesture of an object in the activation zone.

### CROSS-REFERENCE TO RELATED APPLICATIONS

This application is a continuation application of U.S. Non-Provisional application Ser. No. 17/702,369, filed Mar. 23, 2022, the entire disclosure of which is hereby incorporated by reference, which claims the benefit of U.S. Provisional Application No. 63/242,481, filed Sep. 9, 2021, and 63/165,070, filed Mar. 23, 2021, the entire disclosures of which are hereby incorporated by reference.

### FIELD

The present invention relates generally to an electronic plumbing system including gesture control and, more particularly, to an electronic plumbing system including gesture control with a single sensor.

### BACKGROUND

Electronic plumbing systems, such as electronic faucets and electronic showers, are well known. Such electronic plumbing systems are used in residential and commercial applications, such as in kitchens, bathrooms, and various other locations. Users desire to use electronic plumbing systems. Many difficulties can be encountered in using electronic plumbing systems.

### SUMMARY

The present invention provides an electronic plumbing system including gesture control.

### BRIEF DESCRIPTION OF THE DRAWINGS

FIG. 1 is a schematic illustration of fluidic components of an electronic plumbing system according to an exemplary embodiment of the present invention;

FIGS. 2a and 2b are schematic illustrations of electrical/electronic components of electronic plumbing systems according to exemplary embodiments of the present invention—FIG. 2a includes a manual input device(s) and a parameter/position sensor, and FIG. 2b does not include a manual input device(s) or a parameter/position sensor;

FIGS. 3a-1-3a-3 and 3b-1-3b-3 are illustrations of electronic plumbing systems, including electronic faucets, according to exemplary embodiments of the present invention—FIGS. 3a-1-3a-3 include activation sensor/display assemblies, a handle, and a parameter/position sensor, and FIGS. 3b-1-3b-3 include the activation sensor/display assemblies, but do not include a handle or a parameter/position sensor;

FIG. 4 is a schematic illustration of gestures detected by an activation sensor of an electronic plumbing system according to an exemplary embodiment of the present invention;

FIGS. 5a-5c are schematic illustrations of gestures detected by an activation sensor of an electronic plumbing system and corresponding values of parameters for water flowing through the electronic plumbing system according to exemplary embodiments of the present invention;

FIG. 6 is a schematic illustration of gestures detected by an activation sensor of an electronic plumbing system and corresponding parameters for water flowing through the electronic plumbing system together with an illustration of a mobile device screen for inputting and displaying values of some of the parameters for water corresponding to some of the gestures according to an exemplary embodiment of the present invention; and

FIGS. 7a-7c are flowcharts illustrating operation of an electronic plumbing system including gesture control according to an exemplary embodiment of the present invention.

### DETAILED DESCRIPTION

The present invention provides an electronic plumbing system including gesture control. In exemplary embodiments, the electronic plumbing system includes an electronic faucet. However, one of ordinary skill in the art will appreciate that the electronic plumbing system could include other electronic plumbing devices, such as an electronic shower, an electronic showerhead, an electronic handheld shower, an electronic body spray, and an electronic side spray.

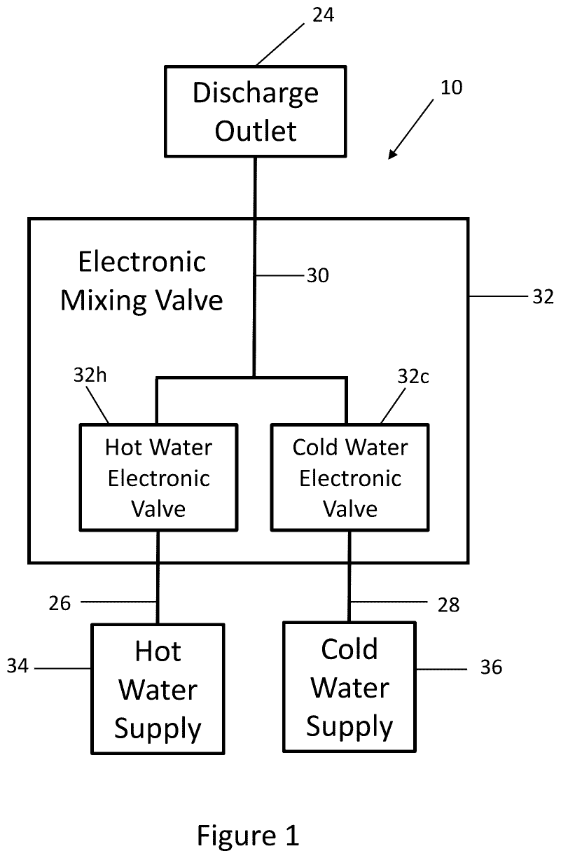

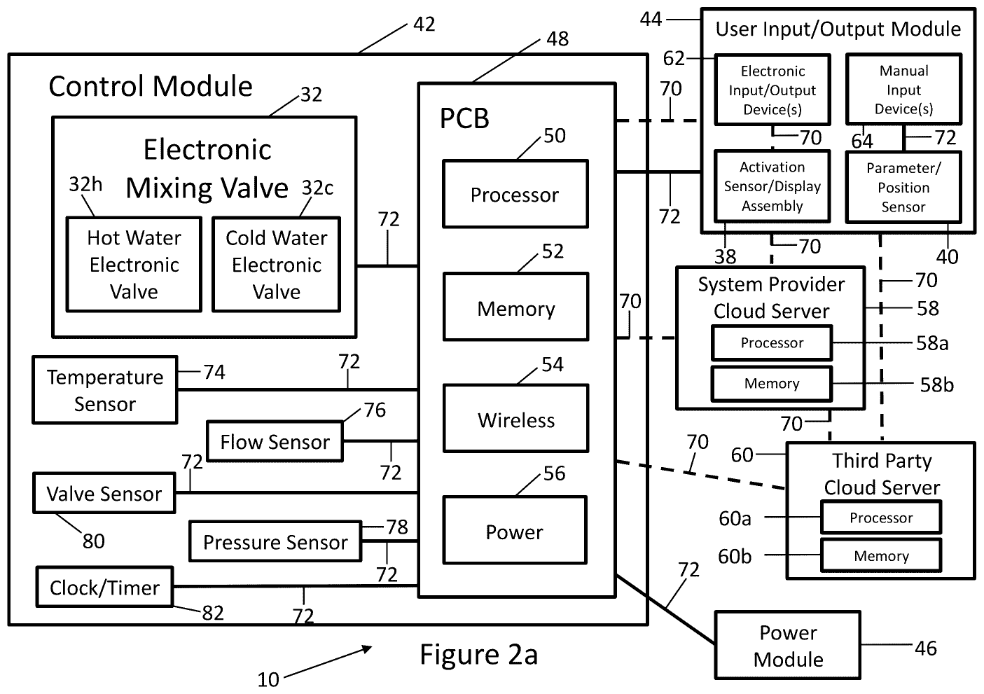

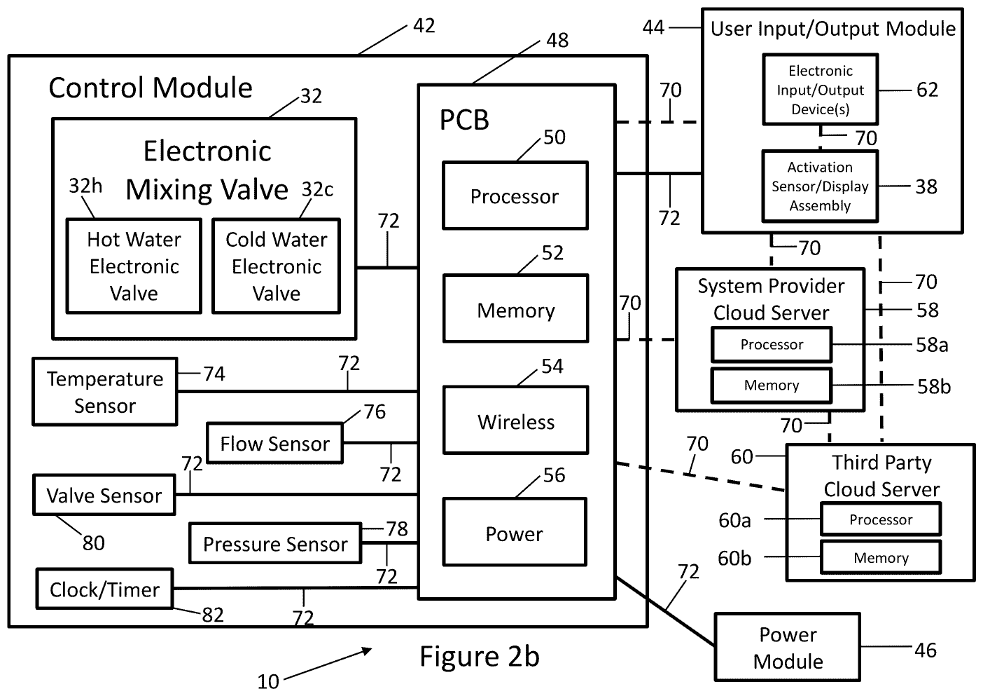

Exemplary embodiments of electronic plumbing systems 10 are illustrated in FIGS. 1 and 2a-2b. FIG. 1 primarily shows the fluidic components and connections of the electronic plumbing systems 10, and FIGS. 2a-2b primarily show the electrical/electronic components and connections of the electronic plumbing systems 10. Exemplary embodiments of electronic plumbing systems 10 including electronic faucets 12 are illustrated in FIGS. 3a-1-3a-3 and 3b-1-3b-3. FIGS. 3a-1-3a-3 and 3b-1-3b-3 show the fluidic and electrical/electronic components of the electronic plumbing systems 10 including electronic faucets 12.

In the illustrated embodiments, as best shown in FIGS. 3a-1-3a-3, the electronic faucet 12 includes a hub 14, a spout 16, a wand hose 18, a wand 20, and a handle 22. An upstream end of the hub 14 is connected to a mounting surface M (such as a counter or sink). An upstream end of the spout 16 is connected to a downstream end of the hub 14. The spout 16 is operable to rotate relative to the hub 14. The wand hose 18 extends through the hub 14 and the spout 16 and is operable to move within the hub 14 and the spout 16. An upstream end of the wand 20 is mounted in a downstream end of the spout 16 and is connected to a downstream end of the wand hose 18. A downstream end of the wand 20 includes a discharge outlet 24. The discharge outlet 24 is operable to deliver water from the electronic faucet 12. The wand 20 is operable to pull away from the spout 16. Pull-out and pull-down wands are well-known in the art and, thus, the operation thereof will not be described in greater detail. The handle 22 is connected to a side of the hub 14 and is operable to move relative to the hub 14. Although the electronic faucet 12 has been described as having a rotatable spout 16 and a handle 22 mounted on the hub 14, one of ordinary skill in the art will appreciate that, in certain embodiments, the spout 16 could be fixed relative to the hub 14, the handle 22 could be mounted on other locations on the electronic faucet 12 or remote from the electronic faucet 12, the electronic faucet 12 could include more than one handle 22, the handle 22 could be any mechanical actuation device or user interface, and/or the electronic faucet 12 may not include the handle 22. The embodiments in which the electronic faucet 12 does not include the handle 22 are shown in FIGS. 3b-1-3b-3. In the illustrated embodiments, the hub 14, the spout 16, and the wand 20 together form a body. However, one of ordinary skill in the art will appreciate that the body does not need to include each of these components.

Additionally, in the illustrated embodiments, as best shown in FIGS. 1, 3a-1-3a-3, and 3b-1-3b-3, the electronic plumbing system 10 includes a hot water line 26, a cold water line 28, a mixed water line 30, and an electronic valve 32. The electronic valve 32 is operable to permit flow of water through the discharge outlet 24 when the electronic valve 32 is activated and to not permit flow of water through the discharge outlet 24 when the electronic valve 32 is deactivated. In the illustrated embodiments, the electronic valve 32 is an electronic mixing valve that includes a hot water electronic valve 32h and a cold water electronic valve 32c.

An upstream end of the hot water line 26 connects to a hot water supply 34, and an upstream end of the cold water line 28 connects to a cold water supply 36. A downstream end of the hot water line 26 connects to the electronic valve 32, and a downstream end of the cold water line 28 connects to the electronic valve 32. More particularly, a downstream end of the hot water line 26 connects to the hot water electronic valve 32h, and a downstream end of the cold water line 28 connects to the cold water electronic valve 32c.

An upstream end of the mixed water line 30 connects to the electronic valve 32. More particularly, an upstream end of the mixed water line 30 connects to the hot water electronic valve 32h and the cold water electronic valve 32c. A downstream end of the mixed water line 30 connects to the discharge outlet 24. In the illustrated embodiments, at least a portion of the mixed water line 30 is the wand hose 18. As stated above, the downstream end of the wand hose 18 connects to the upstream end of the wand 20, and the downstream end of the wand 20 includes the discharge outlet 24 through which water is delivered from the electronic faucet 12.

In the illustrated embodiments, each portion of the hot water line 26, the cold water line 28, and the mixed water line 30 is shown as including at least one hose, pipe, or passage. However, one of ordinary skill in the art will appreciate that each portion of the hot water line 26, the cold water line 28, and the mixed water line 30 could include more than one hose, pipe, or passage. Similarly, each portion of the hot water line 26, the cold water line 28, and the mixed water line 30 could include a combination of hose(s), pipe(s), and/or passage(s). In exemplary embodiments, the hoses are flexible hoses. However, one of ordinary skill in the art will appreciate that other types of hoses could be used. If a portion of the hot water line 26, the cold water line 28, or the mixed water line 30 includes more than one hose, pipe, and/or passage, the hose(s), pipe(s), and/or passage(s) are connected via connectors. In exemplary embodiments for the flexible hoses, the connectors are push-fit connectors. However, one of ordinary skill in the art will appreciate that other types of connectors could be used.

When reference is made to one component of the electronic plumbing system 10 connecting to another component of the electronic plumbing system 10, the connection may be direct or indirect. One of ordinary skill in the art will appreciate that additional components may be needed if the connection is indirect.

In the illustrated embodiments, the electronic plumbing system 10 includes the electronic valve 32 and, more particularly, the hot water electronic valve 32h and the cold water electronic valve 32c. However, one of ordinary skill in the art will appreciate that the electronic plumbing system 10 could include one or more electronic valves. Additionally, the electronic plumbing system 10 could include one or more mechanical valves, either in parallel or in series with the electronic valve(s). Further, although the electronic plumbing system 10 has been described as including the electronic valve 32 that is an electronic mixing valve, one of ordinary skill in the art will appreciate that the electronic plumbing system 10 could include just the hot water electronic valve 32h or just the cold water electronic valve 32c.

In exemplary embodiments, the hot water electronic valve 32h and the cold water electronic valve 32c are proportional valves and, more specifically, stepper motor actuated valves. However, one of ordinary skill in the art will appreciate that the hot water electronic valve 32h and the cold water electronic valve 32c could be any type of electronic valves, including, but not limited to, solenoid valves and electronic throttle valves.

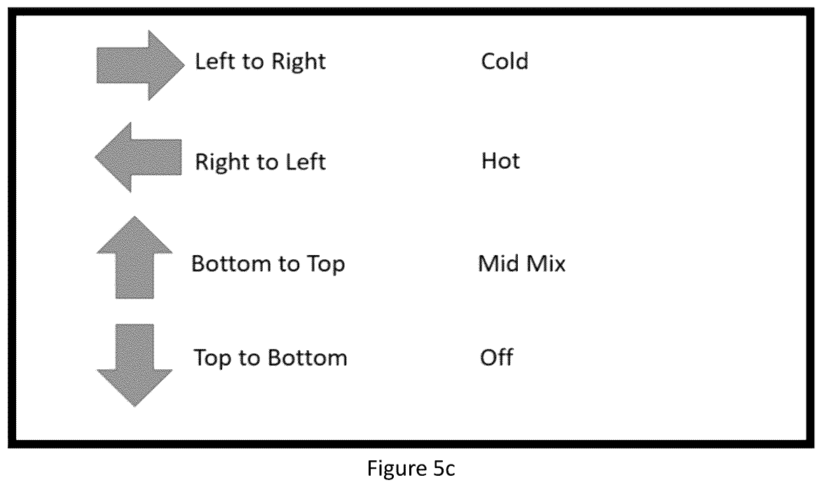

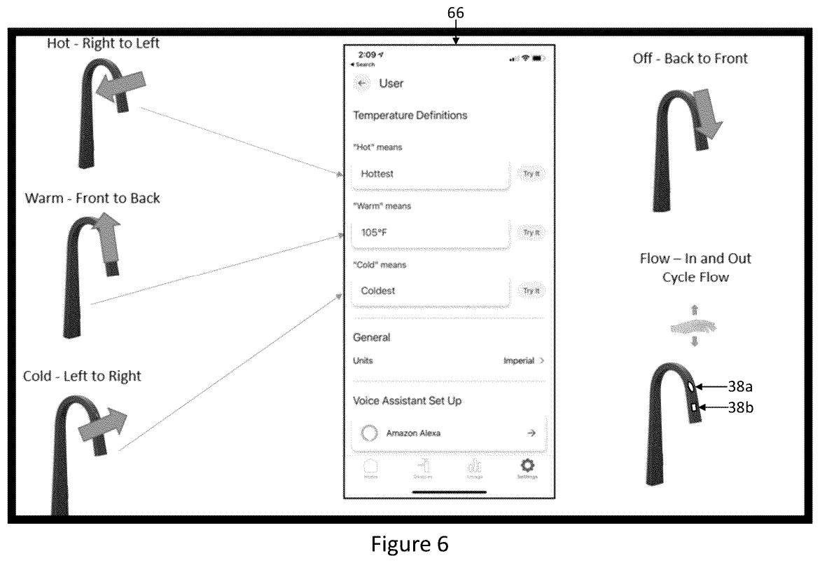

Further, in the illustrated embodiments, as best shown in FIGS. 2a-2b, 3a-1-3a-3, 3b-1-3b-3, and 6, the electronic plumbing system 10 includes an activation sensor/display assembly 38. In the illustrated embodiments, as best shown in FIGS. 3a-1-3a-3, 3b-1-3b-3, and 6, the electronic faucet 12 includes the activation sensor/display assembly 38. In exemplary embodiments, the activation sensor/display assembly 38 is operable to be mounted on the electronic plumbing system 10, such as the electronic faucet 12. In the illustrated embodiments, as best shown in FIGS. 3a-1-3a-3, 3b-1-3b-3, and 6, the activation sensor/display assembly 38 is mounted on the spout 16 and/or on the wand 20 of the electronic faucet 12. More specifically, in the illustrated embodiments of FIGS. 3a-1-3a-3 and 3b-1-3b-3, the activation sensor/display assembly 38 is mounted on an apex of the spout 16, on a front of the spout 16, and on the wand 20; and in the illustrated embodiment of FIG. 6, the activation sensor/display assembly 38 is mounted on the front of the spout 16. However, one of ordinary skill in the art will appreciate that the activation sensor/display assembly 38 could be mounted in any one or more of these and/or other locations on and/or around the electronic plumbing system 10.

In the illustrated embodiments, as best shown in FIGS. 3a-1-3a-3, 3b-1-3b-3, and 6, the activation sensor/display assembly 38 includes an activation sensor 38a. The activation sensor 38a is commonly referred to as a gesture sensor. In the illustrated embodiments, as best shown in FIGS. 3a-1-3a-3, 3b-1-3b-3, and 6, the electronic faucet 12 includes the activation sensor 38a. In exemplary embodiments, the activation sensor 38a is operable to be mounted on the electronic plumbing system 10, such as the electronic faucet 12. In the illustrated embodiments, as best shown in FIGS. 3a-1-3a-3, 3b-1-3b-3, and 6, the activation sensor 38a is mounted on the spout 16 and/or on the wand 20 of the electronic faucet 12. More specifically, in the illustrated embodiments of FIGS. 3a-1-3a-3 and 3b-1-3b-3, the activation sensor 38a is mounted on the apex of the spout 16, on the front of the spout 16, and on the wand 20; and in the illustrated embodiments of FIG. 6, the activation sensor 38a is mounted on the front of the spout 16. However, one of ordinary skill in the art will appreciate that the activation sensor 38a could be mounted in any one or more of these and/or other locations on and/or around the electronic plumbing system 10.

The activation sensor 38a is operable to define an activation zone. In exemplary embodiments, the activation sensor 38a is operable to activate, deactivate, and control the electronic plumbing system 10 (such as the electronic faucet 12) including the electronic valve 32, based on a gesture(s) of an object in the activation zone. As used herein, an “object” can be any portion of a user's body or any item used by the user to trigger the activation sensor 38a. In exemplary embodiments, the activation zone extends generally outwardly from the activation sensor 38a. In the illustrated embodiments of FIGS. 3a-1-3a-3, 3b-1-3b-3, and 6, the activation zone extends generally outwardly from the spout 16 and/or from the wand 20 of the electronic faucet 12. More specifically, in the illustrated embodiments of FIGS. 3a-1-3a-3 and 3b-1-3b-3, the activation zone extends generally outwardly from the apex of the spout 16, from the front of the spout 16, and from the wand 20; and in the illustrated embodiments of FIG. 6, the activation zone extends generally outwardly from the front of the spout 16. The activation sensor 38a will be described in greater detail below.

In the illustrated embodiments, as best shown in FIGS. 3a-1-3a-3, 3b-1-3b-3, and 6, the activation sensor/display assembly 38 includes an activation display 38b. In the illustrated embodiments, as best shown in FIGS. 3a-1-3a-3, 3b-1-3b-3, and 6, the electronic faucet 12 includes the activation display 38b. In exemplary embodiments, the activation display 38b is operable to be mounted on the electronic plumbing system 10, such as the electronic faucet 12. In the illustrated embodiments, as best shown in FIGS. 3a-1-3a-3, 3b-1-3b-3, and 6, the activation display 38b is mounted on the spout 16 and/or on the wand 20 of the electronic faucet 12. More specifically, in the illustrated embodiments of FIGS. 3a-1-3a-3 and 3b-1-3b-3, the activation display 38b is mounted on the apex of the spout 16, on the front of the spout 16, and on the wand 20; and in the illustrated embodiment of FIG. 6, the activation display 38b is mounted on the front of the spout 16. However, one of ordinary skill in the art will appreciate that the activation display 38b could be mounted in any one or more of these and/or other locations on and/or around the electronic plumbing system 10.

In exemplary embodiments, the activation display 38b is operable to convey to the user information regarding the activation, deactivation, and control of the electronic plumbing system 10 (such as the electronic faucet 12) including the electronic valve 32. In exemplary embodiments, the activation display 38b is operable to convey to the user other information (e.g., information regarding other devices in the vicinity of the electronic faucet 12, the time of day, or the weather). The activation display 38b will be described in greater detail below.

Although the activation sensor/display assembly 38 has been described as including both the activation sensor 38a and the activation display 38b, one of ordinary skill in the art will appreciate that the activation sensor/display assembly 38 could include just the activation sensor 38a or just the activation display 38b. Additionally, the activation sensor/display assembly 38 could include any number of the activation sensors 38a and any number of the activation displays 38b. Further, in exemplary embodiments, the activation sensor/display assembly 38, including the activation sensor(s) 38a and/or the activation display(s) 38b, may be combined in a single assembly or separated into a plurality of assemblies. In exemplary embodiments where the activation sensor/display assembly 38 is separated into a plurality of assemblies, each separate assembly could include the activation sensor(s) 38a and/or the activation display(s) 38b. For example, the activation sensor/display assembly 38 could include a first activation sensor 38a on the apex of the spout 16, a second activation sensor 38a on the front of the spout 16, and an activation display 38b on the wand 20. Alternatively, the activation sensor/display assembly 38 could include a first activation sensor 38a on a front of the hub 14, a second activation sensor 38a on the apex of the spout 16, and an activation display 38b on the front of the spout 16.

In the illustrated embodiments, the handle 22 operates as it would with a standard faucet. In other words, the handle 22 can be moved between various positions to indicate a desired temperature, flow rate, and/or volume of water discharged from the electronic faucet 12.

In the illustrated embodiments, as best shown in FIGS. 3a-1-3a-3, although the handle 22 does not control a mechanical valve, the handle 22 operates as it would with a standard faucet. In other words, the handle 22 can be moved between various positions to indicate a desired temperature, flow rate, and/or volume of water discharged from the electronic faucet 12.

More specifically, with regard to the temperature of water, the handle 22 can be rotated about a longitudinal axis of a side opening in the hub 14. At one extent of a range of rotation, the position of the handle 22 indicates all hot water (a full hot position). At the other extent of the range of rotation, the position of the handle 22 indicates all cold water (a full cold position). In between the extents of the range of rotation, the position of the handle 22 indicates a mix of hot and cold water (mixed temperature positions) with hotter temperature water as the position nears the full hot extent of the range of rotation and colder temperature water as the position nears the full cold extent of the range of rotation.

With regard to the flow rate/volume of water, the handle 22 can be moved toward and away from the side opening in the hub 14. At one extent of a range of movement, the position of the handle 22 indicates no flow rate/volume of water (a full closed position). At the other extent of the range of movement, the position of the handle 22 indicates full flow rate/volume of water (a full open position). In between the extents of the range of movement, the position of the handle 22 indicates an intermediate flow rate/volume of water (less than full open positions) with reduced flow rate/volume of water as the position nears the full closed extent of the range of movement and increased flow rate/volume of water as the position nears the full open extent of the range of movement.

In exemplary embodiments, the electronic faucet 12 is operable to detect movement of the handle 22 and to provide information to set at least one parameter for water flowing through the hot water electronic valve 32h and the cold water electronic valve 32c based on the movement of the handle 22. The electronic faucet 12 is operable to detect movement of the handle 22 either directly or indirectly. In exemplary embodiments, based on the movement of the handle 22, the electronic faucet 12 provides information to set a temperature, flow rate, and/or volume of water flowing through the hot water electronic valve 32h and the cold water electronic valve 32c.

Additionally, in the illustrated embodiments, as best shown in FIGS. 2a and 3a-1-3a-3, the electronic plumbing system 10 includes a parameter or position sensor 40. In the illustrated embodiments, as best shown in FIGS. 3a-1-3a-3, the electronic faucet 12 includes the parameter or position sensor 40. In exemplary embodiments, the parameter or position sensor 40 is operable to detect a handle state 22 (such as a position or a movement of the handle 22) and to provide information to set at least one parameter for water flowing through the hot water electronic valve 32h and the cold water electronic valve 32c based on the handle state 22 (such as the position or the movement of the handle 22). The parameter or position sensor 40 is operable to detect the handle state 22 (such as the position or the movement of the handle 22), ranging from the full hot position through the full cold position and from the full closed position through the full open position. The parameter or position sensor 40 is operable to detect the handle state 22 (such as the position or the movement of the handle 22) either directly or indirectly. In exemplary embodiments, based on the handle state 22 (such as the position or the movement of the handle 22), the parameter or position sensor 40 provides information to set a temperature, flow rate, and/or volume of water flowing through the hot water electronic valve 32h and the cold water electronic valve 32c.

An electronic plumbing system and, more particularly, an electronic faucet, including a parameter or position sensor that is operable to detect movement of a handle and to provide information to set at least one parameter (such as a temperature and/or a volume) of water flowing through a hot water electronic valve and a cold water electronic valve based on movement of the handle is disclosed in U.S. Pat. No. 9,212,473, assigned to FB Global Plumbing Group LLC, the entire disclosure of which is hereby incorporated by reference.

Further, in the illustrated embodiments, as best shown in FIGS. 2a-2b, 3a-1-3a-3, and 3b-1-3b-3, the electronic plumbing system 10 includes a control module 42, a user input/output module 44, and a power module 46.

The flow components of the control module 42 include a number of inlets and outlets and a number of flow passages. These inlets/outlets and flow passages enable the easy management of the flow between the incoming flows (i.e., the hot water line 26 and the cold water line 28) and the outgoing flow (i.e., the mixed water line 30 or the wand hose 18).

In the illustrated embodiments, as best shown in FIGS. 3a-1-3a-3 and 3b-1-3b-3, the control module 42 is operable to mount below the mounting surface M (such as the counter or sink). In exemplary embodiments, the control module 42 is operable to mount on a mounting shank of the electronic faucet 12. In the illustrated embodiments, the electronic valve 32 is located inside the control module 42. In the illustrated embodiments, the control module 42 includes a top or first side and a bottom or second side. The first side is opposite the second side. In the illustrated embodiments, the second side includes openings for hoses and flow passages. Although the control module 42 has been described as being mounted below the mounting surface M and the electronic valve 32 has been described as being located inside the control module 42, one of ordinary skill in the art will appreciate that, in certain embodiments, the control module 42 could be mounted in other locations and the electronic valve 32 may not be located inside the control module 42.

In the illustrated embodiments, as best shown in FIGS. 2a-2b, the control module 42 further includes a number of electronic components. These components control the operation of the electronic plumbing system 10 (such as the electronic faucet 12) including the electronic valve 32. More specifically, these components enable the activation, deactivation, and control of the electronic plumbing system 10 (such as the electronic faucet 12) including the electronic valve 32, through user input. In the illustrated embodiments, the control module 42 includes the electronic valve 32 and a printed circuit board (“PCB”) 48. In the illustrated embodiments, a number of electronic components are mounted on the PCB 48, including, but not limited to, a processor 50, memory 52, a wireless communication chip or module 54, and a power port 56. The processor 50 is operable to receive signals from and send signals to the components of the electronic plumbing system 10 to control the operation of the electronic plumbing system 10 (such as the electronic faucet 12) including the electronic valve 32. For example, the processor 50 is operable to receive signals from sensors, the user input/output module 44, and other components of the electronic plumbing system 10 (described above and to be described in greater detail below) and send signals to the electronic valve 32, the user input/output module 44, and other components of the electronic plumbing system 10 to activate, deactivate, and control the electronic plumbing system 10 (such as the electronic faucet 12) including the electronic valve 32. The memory 52 is operable to save information received from the components of the electronic plumbing system 10.

Additionally, in the illustrated embodiments, as best shown in FIGS. 2a-2b, the electronic plumbing system 10 includes a system provider cloud server 58 and a third party cloud server 60. The system provider cloud server 58 could be hosted by a system provider (such as an electronic plumbing system manufacturer), and the third party cloud server 60 could be hosted by a third party (such as Amazon, Google, HomeKit, and IFTTT). In the illustrated embodiments, as best shown in FIGS. 2a-2b, each of the system provider cloud server 58 and the third party cloud server 60 includes a processor 58a, 60a and memory 58b, 60b. The signals received from and sent to the components of the electronic plumbing system 10 to control the operation of the electronic plumbing system 10 can be received from and sent to the processor 58a in the system provider cloud server 58 and/or the processor 60a in the third party cloud server 60 in addition to or alternatively to the processor 50 in the control module 42. Similarly, the information received from the components of the electronic plumbing system 10 can be saved in the memory 58b in the system provider cloud server 58 and/or the memory 60b in the third party cloud server 60 in addition to or alternatively to the memory 52 in the control module 42. Further, the information received from the components of the electronic plumbing system 10 can be saved in the user input/output module 44 (where the user input/output module 44 includes memory, such as an Apple iPhone and a Google Android phone).

As used herein, unless stated otherwise, “processor” includes any one or more of the processor 50 in the control module 42, the processor 58a in the system provider cloud server 58, and the processor 60a in the third party cloud server 60. Similarly, as used herein, unless stated otherwise, “memory” includes any one or more of the memory 52 in the control module 42, the memory 58b in the system provider cloud server 58, the memory 60b in the third party cloud server 60, and the memory in the user input/output module 44.

In exemplary embodiments, the user input/output module 44 is operable to receive input (e.g., information and/or instructions) from the user, provide the input to the components of the electronic plumbing system 10 (e.g., the processor), receive output (e.g., information and/or notifications) from the components of the electronic plumbing system 10 (e.g., the processor), and display the output to the user. In exemplary embodiments, the user input/output module 44 is operable to receive input from the user and send signals to the processor to control the operation of the electronic plumbing system 10 (such as the electronic faucet 12) including the electronic valve 32. For example, the user input/output module 44 is operable to receive input from the user and send signals to the processor to activate, deactivate, and control the electronic plumbing system 10 (such as the electronic faucet 12) including the electronic valve 32. Additionally, the user input/output module 44 is operable to receive signals from the processor and display output to the user. The user input/output module 44 can send signals to and receive signals from the processor directly and/or indirectly (e.g., through other components of the electronic plumbing system 10 and/or through other components outside of the electronic plumbing system 10).

The user input/output module 44 can include any device that enables input from the user and/or output to the user. The user input/output module 44 includes electronic input/output device(s) 62 and manual input device(s) 64. Exemplary electronic input/output devices 62 include activation sensor/display assemblies (including activation sensors and activation displays), mobile devices, voice controlled devices, touch screen devices, and push button devices. Exemplary manual input/output devices 64 include handles and joysticks.

In the illustrated embodiments of FIGS. 3a-1-3a-3, the user input/output module 44 includes three electronic input/output devices 62 and one manual input device 64, i.e., the activation sensor/display assembly 38 (including the activation sensor 38a and the activation display 38b) on the electronic faucet 12, a mobile device 66 that can be held and/or moved by the user, a voice controlled device 68 located on the mounting surface M that can be held and/or moved by the user, and the handle 22 connected to the hub 14 of the electronic faucet 12 located on the mounting surface M. In the illustrated embodiments of FIGS. 3b-1-3b-3, the user input/output module 44 includes three electronic input/output devices 62, i.e., the activation sensor/display assembly 38 (including the activation sensor 38a and the activation display 38b) on the electronic faucet 12, the mobile device 66 that can be held and/or moved by the user, and the voice controlled device 68 located on the mounting surface M that can be held and/or moved by the user. In the illustrated embodiments of FIGS. 3b-1-3b-3, the user input/output module 44 does not include any manual input device 64, i.e., the handle 22.

One of ordinary skill in the art will appreciate that the user input/output module 44 could include any number of devices, and each device of the user input/output module 44 could include any number of components. Moreover, one of ordinary skill in the art will appreciate that each device of the user input/output module 44 could be in any location where it can, at some point in time, send signals to and/or receive signals from other components of the electronic plumbing system 10 (e.g., the processor), or each device of the user input/output module 44 could be integrally formed with or physically connected to other components of the electronic plumbing system 10 (e.g., the control module 42). For example, the voice controlled device 68 could be integrated into the electronic faucet 12.

In the illustrated embodiments, as best shown in FIGS. 2a-2b, 3a-1-3a-3, and 3b-1-3b-3, the power module 46 is operable to provide power to the electrical/electronic components of the electronic plumbing system 10. In the illustrated embodiments, the power module 46 is operable to mount below the mounting surface M. In exemplary embodiments, the power module 46 includes battery power. In exemplary embodiments, the power module 46 includes AC power. Although the power module 46 has been described as being mounted below the mounting surface M, one of ordinary skill in the art will appreciate that, in certain embodiments, the power module 46 could be mounted in other locations.

Further, in the illustrated embodiments, the electronic plumbing system 10 includes sensors. In the illustrated embodiments, the sensors include the activation sensor 38a, the parameter or position sensor 40, a temperature sensor 74, a flow sensor 76, a pressure sensor 78, and a valve sensor 80. The activation sensor 38a and the parameter or position sensor 40 were described above. The temperature sensor 74 is operable to detect a temperature of water in the hot water line 26, the cold water line 28, the electronic valve 32, and/or the mixed water line 30 or wand hose 18. The flow sensor 76 is operable to detect a flow rate of water in the hot water line 26, the cold water line 28, the electronic valve 32, and/or the mixed water line 30 or wand hose 18. The pressure sensor 78 is operable to detect a pressure of water in the hot water line 26, the cold water line 28, the electronic valve 32, and/or the mixed water line 30 or wand hose 18. The valve sensor 80 is operable to detect a position of the electronic valve 32 and/or a motor driving the electronic valve 32. The sensors are operable to send signals to the processor indicating the detected information.

The information detected by the sensors is used to control the operation of the electronic plumbing system 10. For example, the information detected by the activation sensor 38a can be used to activate and deactivate the electronic plumbing system 10 and/or to determine a temperature, flow rate, volume, and/or other parameter(s) for water desired by the user. The information detected by the parameter or position sensor 40 can be used to determine a temperature, flow rate, and/or volume of water desired by the user. The information detected by the temperature sensor 74 can be used to maintain a temperature of water discharged from the electronic plumbing system 10. The information detected by the flow sensor 76 can be used to determine if there is flow or maintain a flow rate of water discharged from the electronic plumbing system 10. The information detected by the pressure sensor 78 can be used to maintain a pressure or determine a volume of water discharged from the electronic plumbing system 10. The information detected by the valve sensor 80 can be used to open and close the electronic valve 32.

Although the electronic plumbing system 10 has been described as including the activation sensor 38a, the parameter or position sensor 40, the temperature sensor 74, the flow sensor 76, the pressure sensor 78, and the valve sensor 80, one of ordinary skill in the art will appreciate that, in certain embodiments, the electronic plumbing system 10 could include other sensors or may not include all these sensors depending on which parameter(s) for the water discharged from the electronic plumbing system 10 are desired to be controlled.

Additionally, in the illustrated embodiments, the electronic plumbing system 10 includes a clock/timer 82. The clock/timer 82 is operable to provide a date and a time of an action or to measure time intervals. For example, the clock/timer 82 can provide a date and a time of an activation, a deactivation, or a control of the electronic plumbing system 10 or measure a time interval between an activation, a deactivation, and a control of the electronic plumbing system 10. In exemplary embodiments, the processor includes an internal clock/timer. Any timing of actions or steps described herein could be provided by the clock/timer 82 or the internal clock/timer of the processor.

In exemplary embodiments, some components of the electronic plumbing system 10 are connected to each other via a wireless communication connection or network interface 70, while other components of the electronic plumbing system 10 are connected to each other via a wired communication connection or network interface 72. In exemplary embodiments, some components of the electronic plumbing system 10 are operable to send signals to and/or receive signals from each other via the wireless communication connection or network interface 70, while other components of the electronic plumbing system 10 are operable to send signals to and/or receive signals from each other via the wired communication connection or network interface 72.

One of ordinary skill in the art will appreciate that each component of the electronic plumbing system 10 could be connected to each other component of the electronic plumbing system 10 and send signals to and/or receive signals from each other component of the electronic plumbing system 10 via any one type or combination of different types of wireless communication connection(s) or network interface(s) 70 and/or wired communication connection(s) or network interface(s) 72. Further, one of ordinary skill in the art will appreciate that the wireless communication connection or network interface 70 and/or the wired communication connection or network interface 72 could be direct or indirect (e.g., via a router or a network hub). Moreover, one of ordinary skill in the art will appreciate that the wireless communication connection or network interface 70 could include any one type or any combination of different types of wireless communication connection(s) or network interface(s), including, but not limited to, Wi-Fi, Bluetooth, cellular, near field communication (NFC), Zigbee, and Z-Wave.

In the illustrated embodiments, as best shown in FIGS. 2a-2b, some components of the user input/output module 44 (e.g., the electronic input/output device(s) 62) are connected to other components of the electronic plumbing system 10 (e.g., the processor) via the wireless communication connection or network interface 70, while other components of the user input/output module 44 (e.g., the activation sensor/display assembly 38 and the parameter or position sensor 40) are connected to other components of the electronic plumbing system 10 (e.g., the processor 50) via the wired communication connection or network interface 72. In the illustrated embodiments, as best shown in FIGS. 2a-2b, some components of the user input/output module 44 (e.g., the electronic input/output device(s) 62) are operable to send signals to and/or receive signals from other components of the electronic plumbing system 10 (e.g., the processor) via the wireless communication connection or network interface 70, while other components of the user input/output module 44 (e.g., the activation sensor/display assembly 38 and the parameter or position sensor 40) are operable to send signals to and/or receive signals from other components of the electronic plumbing system 10 (e.g., the processor 50) via the wired communication connection or network interface 72.

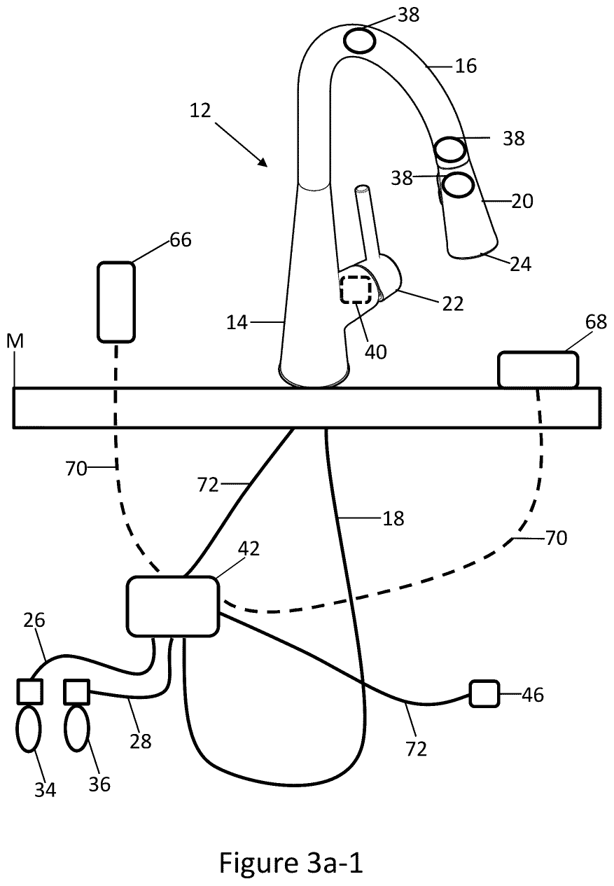

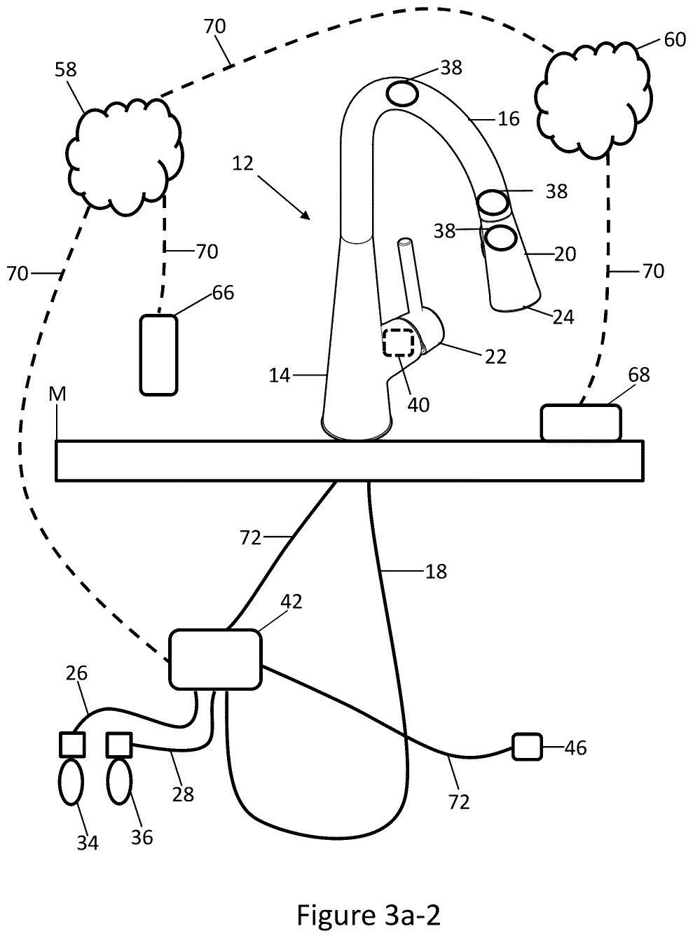

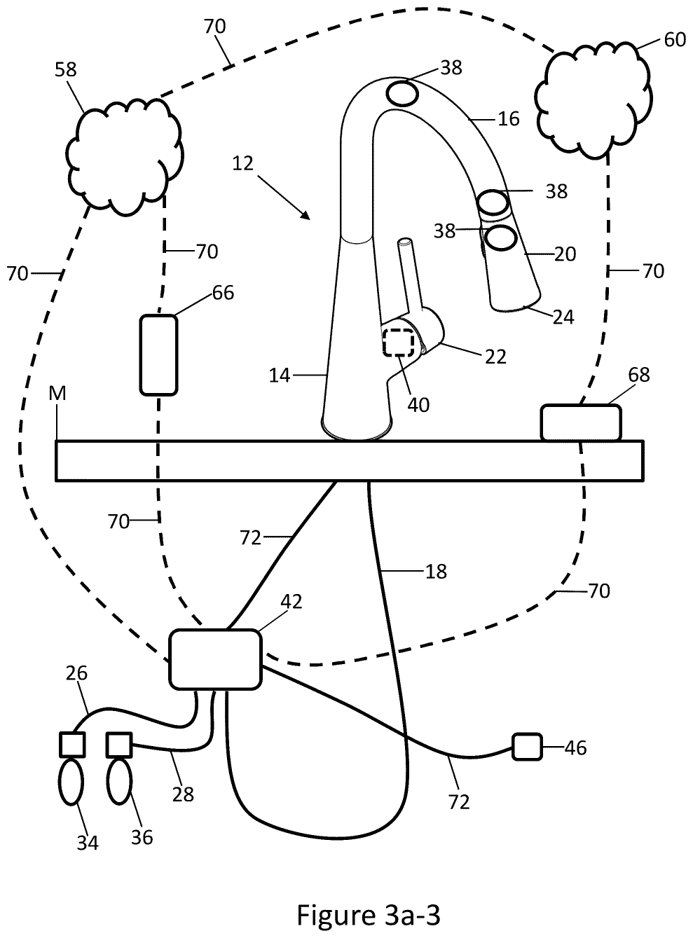

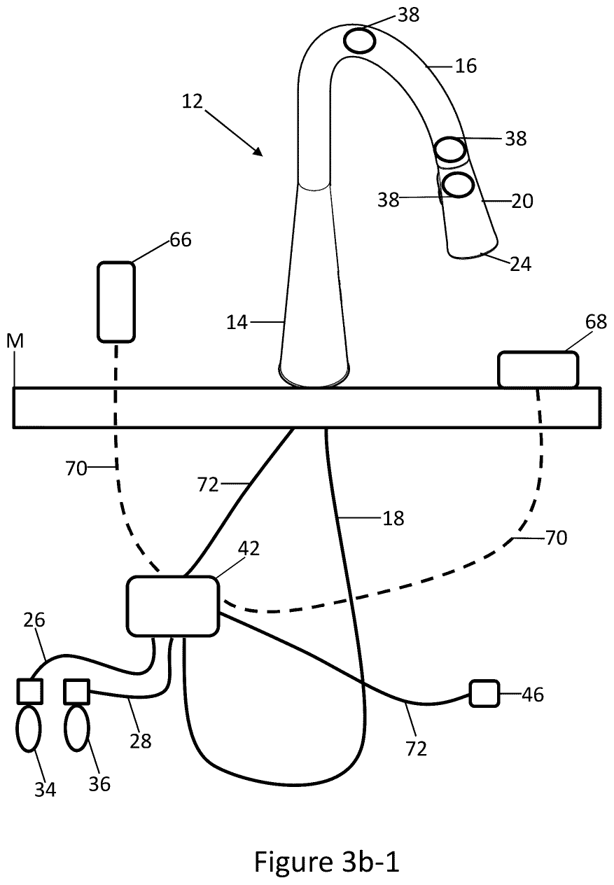

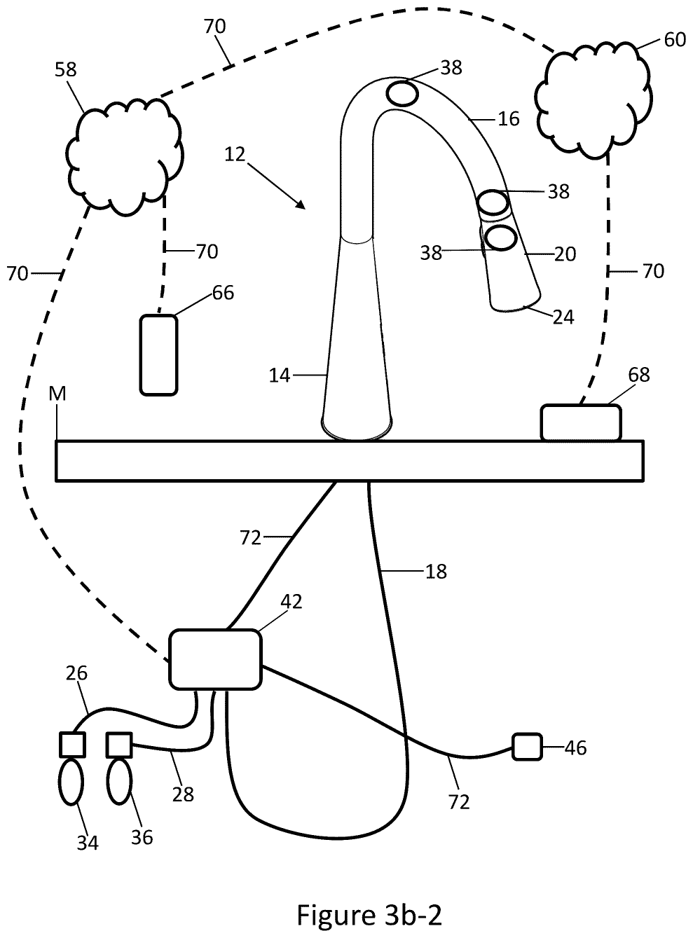

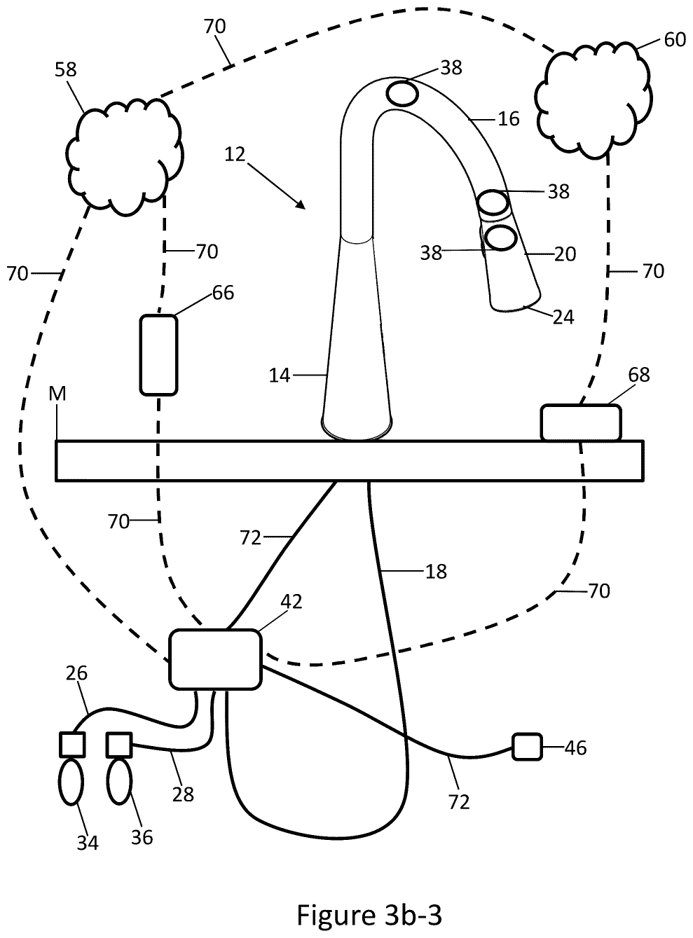

For example, in the illustrated embodiments, as best shown in FIGS. 3a-1 and 3b-1, the mobile device 66 and the voice controlled device 68 are connected to the control module 42 via the wireless communication connection or network interface 70. As stated above, this wireless communication connection or network interface 70 could be direct or indirect. In the illustrated embodiments, as best shown in FIGS. 3a-2 and 3b-2, the mobile device 66 and the voice controlled device 68 are connected to the control module 42 via the system provider cloud server 58 and/or the third party cloud server 60 (i.e., the wireless communication connection or network interface 70 is indirect). In the illustrated embodiments, as best shown in FIGS. 3a-3 and 3b-3, the mobile device 66 and the voice controlled device 68 are connected to the control module 42 via multiple different wireless communication connections or network interfaces 70 to provide redundancy in the event of a failure of one of the wireless communication connections or network interfaces 70. As stated above, each of these wireless communication connections or network interfaces 70 could be direct or indirect.

As stated above, one of ordinary skill in the art will appreciate that each component of the user input/output module 44 could be connected to each other component of the electronic plumbing system 10 (e.g., the processor) and send signals to and/or receive signals from each other component of the electronic plumbing system 10 (e.g., the processor) via any one type or combination of different types of wireless communication connection(s) or network interface(s) 70 and/or wired communication connection(s) or network interface(s) 72. Further, one of ordinary skill in the art will appreciate that the wireless communication connection or network interface 70 and/or the wired communication connection or network interface 72 could be direct or indirect (e.g., via a router or a network hub). Moreover, one of ordinary skill in the art will appreciate that the wireless communication connection or network interface 70 could include any one type or any combination of different types of wireless communication connection(s) or network interface(s), including, but not limited to, Wi-Fi, Bluetooth, cellular, near field communication (NFC), Zigbee, and Z-Wave.

In the illustrated embodiments, as best shown in FIGS. 2a-2b, 3a-2-3a-3, and 3b-2-3b-3, the system provider cloud server 58 and the third party cloud server 60 are connected to other components of the electronic plumbing system 10 (e.g., the processor 50) via the wireless communication connection or network interface 70. In the illustrated embodiments, as best shown in FIGS. 2a-2b, 3a-2-3a-3, and 3b-2-3b-3, the system provider cloud server 58 and the third party cloud server 60 are operable to send signals to and/or receive signals from other components of the electronic plumbing system 10 (e.g., the processor 50) via the wireless communication connection or network interface 70.

As stated above, one of ordinary skill in the art will appreciate that the system provider cloud server 58 and the third party cloud server 60 could be connected to other components of the electronic plumbing system 10 (e.g., the processor 50) and send signals to and/or receive signals from other components of the electronic plumbing system 10 (e.g., the processor 50) via any one type or combination of different types of wireless communication connection(s) or network interface(s) 70 and/or wired communication connection(s) or network interface(s) 72. Further, one of ordinary skill in the art will appreciate that the wireless communication connection or network interface 70 and/or the wired communication connection or network interface 72 could be direct or indirect (e.g., via a router or a network hub). Moreover, one of ordinary skill in the art will appreciate that the wireless communication connection or network interface 70 could include any one type or any combination of different types of wireless communication connection(s) or network interface(s), including, but not limited to, Wi-Fi, Bluetooth, cellular, near field communication (NFC), Zigbee, and Z-Wave.

In the illustrated embodiments, as best shown in FIGS. 2a-2b, 3a-1-3a-3, and 3b-1-3b-3, the sensors (such as the activation sensor 38a, the parameter or position sensor 40, the temperature sensor 74, the flow sensor 76, the pressure sensor 78, and the valve sensor 80) are connected to the control module 42 (and, thus, the processor 50) via the wired communication connection or network interface 72. In the illustrated embodiments, the sensors (such as the activation sensor 38a, the parameter or position sensor 40, the temperature sensor 74, the flow sensor 76, the pressure sensor 78, and the valve sensor 80) are operable to send signals to and/or receive signals from the control module 40 (and, thus, the processor 50) via the wired communication connection or network interface 72. Additionally, in the illustrated embodiments, as best shown in FIGS. 2a-2b, 3a-1-3a-3, and 3b-1-3b-3, the power module 46 is connected to the control module 42 via the wired communication connection or network interface 72.

As stated above, one of ordinary skill in the art will appreciate that the sensors (such as the activation sensor 38a, the parameter or position sensor 40, the temperature sensor 74, the flow sensor 76, the pressure sensor 78, and the valve sensor 80) and the power module 46 could be connected to the control module 42 and/or other components of the electronic plumbing system 10 (e.g., the processor) and send signals to and/or receive signals from the control module 42 and/or other components of the electronic plumbing system 10 (e.g., the processor) via any one type or combination of different types of wireless communication connection(s) or network interface(s) 70 and/or wired communication connection(s) or network interface(s) 72. Further, one of ordinary skill in the art will appreciate that the wireless communication connection or network interface 70 and/or the wired communication connection or network interface 72 could be direct or indirect (e.g., via a router or a network hub). Moreover, one of ordinary skill in the art will appreciate that the wireless communication connection or network interface 70 could include any one type or any combination of different types of wireless communication connection(s) or network interface(s), including, but not limited to, Wi-Fi, Bluetooth, cellular, near field communication (NFC), Zigbee, and Z-Wave.

During operation of the electronic plumbing system 10, the user activates, deactivates, and controls the electronic plumbing system 10 (such as the electronic faucet 12) including the electronic valve 32, using the user input/output module 44. When the user appropriately triggers the user input/output module 44, the electronic plumbing system 10 (such as the electronic faucet 12) including the electronic valve 32, is activated, deactivated, or controlled. For example, the user could trigger the user input/output module 44 by triggering the activation sensor 38a, pressing an appropriate button on the mobile device 66, stating specific commands to the voice controlled device 68, and/or opening, closing, and/or moving the handle 22. For voice control, when the user says “turn on the faucet,” the electronic valve 32 is activated. Similarly, when the user says “turn off the faucet,” the electronic valve 32 is deactivated. Further, when the user says “increase temperature,” “decrease temperature,” “increase flow,” or “decrease flow,” the electronic valve 32 is controlled to accomplish the requested action. The commands can be predetermined. Additionally, the commands can be customizable. For example, the user could activate the electronic valve 32 by saying “start flow” instead of “turn on the faucet.” Similarly, the user could deactivate the electronic valve 32 by saying “stop flow” instead of “turn off the faucet.”

As used herein, “activate a valve” means to move the valve to or maintain the valve in an open position, regardless of the volume, temperature, or other parameter(s) for the flowing water, and “deactivate a valve” means to move the valve to a completely closed position.

When reference is made to activating or deactivating the electronic valve 32 “when the user appropriately triggers the user input/output module 44,” the electronic valve 32 may be activated or deactivated immediately upon the user input/output module 44 being triggered or a predetermined period of time after the user input/output module 44 has been triggered.

In exemplary embodiments, as best shown in FIGS. 2a-2b, 3a-1-3a-3, and 3b-1-3b-3, during operation of the electronic plumbing system 10 (such as the electronic faucet 12) including the electronic valve 32, using the activation sensor/display assembly 38, the user enters input via the activation sensor 38a (e.g., the user triggers the activation sensor 38a). The activation sensor 38a detects the input from the user and sends a signal to the processor 50 in the control module 42 via the wired communication connection or network interface 72. The processor 50 in the control module 42 receives the signal from the activation sensor 38a and sends a signal to the electronic valve 32 via the wired communication connection or network interface 72. The electronic valve 32 receives the signal from the processor 50 in the control module 42 and appropriately activates, deactivates, or controls other parameter(s) for the water delivered through the discharge outlet 24 of the electronic plumbing system 10 (such as the electronic faucet 12).

In exemplary embodiments, as best shown in FIGS. 2a-2b, 3a-1-3a-3, and 3b-1-3b-3, during operation of the electronic plumbing system 10 (such as the electronic faucet 12) including the electronic valve 32, using the mobile device 66, the user enters input via the mobile device 66 (e.g., the user presses a button on the mobile device 66). The mobile device 66 receives the input from the user and sends a signal to the processor 58a in the system provider cloud server 58 via the wireless communication connection or network interface 70. The processor 58a in the system provider cloud server 58 receives the signal from the mobile device 66 and sends a signal to the processor 50 in the control module 42 via the wireless communication or network interface 70. The processor 50 in the control module 42 receives the signal from the processor 58a in the system provider cloud server 58 and sends a signal to the electronic valve 32 via the wired communication connection or network interface 72. The electronic valve 32 receives the signal from the processor 50 in the control module 42 and appropriately activates, deactivates, or controls other parameter(s) for the water delivered through the discharge outlet 24 of the electronic plumbing system 10 (such as the electronic faucet 12).

In exemplary embodiments, as best shown in FIGS. 2a-2b, 3a-1-3a-3, and 3b-1-3b-3, during operation of the electronic plumbing system 10 (such as the electronic faucet 12) including the electronic valve 32, using the voice controlled device 68, the user enters input via the voice controlled device 68 (e.g., the user states a command to the voice controlled device 68). The voice controlled device 68 receives the input from the user and sends a signal to the processor 60a in the third party cloud server 60 via the wireless communication connection or network interface 70. The processor 60a in the third party cloud server 60 receives the signal from the voice controlled device 68 and sends a signal to the processor 58a in the system provider cloud server 58 via the wireless communication connection or network interface 70. The processor 58a in the system provider cloud server 58 receives the signal from the processor 60a in the third party cloud server 60 and sends a signal to the processor 50 in the control module 42 via the wireless communication connection or network interface 70. The processor 50 in the control module 42 receives the signal from the processor 58a in the system provider cloud server 58 and sends a signal to the electronic valve 32 via the wired communication connection or network interface 72. The electronic valve 32 receives the signal from the processor 50 in the control module 42 and appropriately activates, deactivates, or controls other parameter(s) for the water delivered through the discharge outlet 24 of the electronic plumbing system 10 (such as the electronic faucet 12).

In exemplary embodiments, as best shown in FIGS. 2a and 3a-1-3a-3, during operation of the electronic plumbing system 10 (such as the electronic faucet 12) including the electronic valve 32, using the handle 22, the user enters input via the handle 22 (e.g., the user moves the handle 22). The parameter or position sensor 40 detects the handle state 22 (such as the position or the movement of the handle 22 by the user) and sends a signal to the processor 50 in the control module 42 via the wired communication connection or network interface 72. The processor 50 in the control module 42 receives the signal from the parameter or position sensor 40 and sends a signal to the electronic valve 32 via the wired communication connection or network interface 72. The electronic valve 32 receives the signal from the processor 50 in the control module 42 and appropriately activates, deactivates, or controls other parameter(s) for the water delivered through the discharge outlet 24 of the electronic plumbing system 10 (such as the electronic faucet 12).

In exemplary embodiments, as best shown in FIGS. 2a-2b, 3a-1-3a-3, and 3b-1-3b-3, during operation of the electronic plumbing system 10 (such as the electronic faucet 12) including the electronic valve 32, using the activation sensor/display assembly 38, the user receives output via the activation display 38b (e.g., the user receives information on the activation display 38b). The sensor(s) detect information regarding parameter(s) for the water delivered through the discharge outlet 24 of the electronic plumbing system 10, (such as the electronic faucet 12) and send signal(s) to the processor 50 in the control module 42 via the wired communication connection or network interface 72. The processor 50 in the control modules 42 receives the signal(s) from the sensor(s) and sends a signal to the activation display 38b via the wired communication connection or network interface 72. The activation display 38b receives the signal from the processor 50 in the control module 42 and conveys to the user the information regarding parameter(s) for the water (e.g., displays to the user the information).

In exemplary embodiments, as best shown in FIGS. 2a-2b, 3a-1-3a-3, and 3b-1-3b-3, during operation of the electronic plumbing system 10 (such as the electronic faucet 12) including the electronic valve 32, using the mobile device 66, the user receives output via the mobile device 66 (e.g., the user receives information on the mobile device 66). The sensor(s) detect information regarding parameter(s) for the water delivered through the discharge outlet 24 of the electronic plumbing system 10 and send signal(s) to the processor 50 in the control module 42 via the wired communication connection or network interface 72. The processor 50 in the control modules 42 receives the signal(s) from the sensor(s) and sends a signal to the processor 58a in the system provider cloud server 58 via the wireless communication connection or network interface 70. The processor 58a in the system provider cloud server 58 receives the signal from the processor 50 in the control module 42 and sends a signal to the mobile device 66 via the wireless communication connection or network interface 70. The mobile device 66 receives the signal from the processor 58a in the system provider cloud server 58 and conveys to the user the information regarding parameter(s) for the water (e.g., displays to the user the information).

In exemplary embodiments, as best shown in FIGS. 2a-2b, 3a-1-3a-3, and 3b-1-3b-3, during operation of the electronic plumbing system 10 (such as the electronic faucet 12) including the electronic valve 32, using the voice controlled device 68, the user receives output via the voice controlled device 68 (e.g., the user receives information from the voice controlled device 68). The sensor(s) detect information regarding parameter(s) for the water delivered through the discharge outlet 24 of the electronic plumbing system 10 and send signal(s) to the processor 50 in the control module 42 via the wired communication connection or network interface 72. The processor 50 in the control module 42 receives the signal(s) from the sensor(s) and sends a signal to the processor 58a in the system provider cloud server 58 via the wireless communication connection or network interface 70. The processor 58a in the system provider cloud server 58 receives the signal from the processor 50 in the control module 42 and sends a signal to the processor 60a in the third party cloud server 60 via the wireless communication connection or network interface 70. The processor 60a in the system provider cloud server 60 receives the signal from the processor 58a in the system provider cloud server 58 and sends a signal to the voice controlled device 68 via the wireless communication connection or network interface 70. The voice controlled device 68 receives the signal from the processor 60a in the third party cloud server 60 and conveys to the user the information regarding parameter(s) for the water (e.g., speaks to the user the information).

### Gesture Control

In an exemplary embodiment, the electronic plumbing system 10 includes gesture control with a single sensor.

In exemplary embodiments, the user input/output module 44 includes a mechanism (e.g., the activation sensor/display assembly 38 and, more specifically, the activation sensor 38a) to receive from the user desired value(s) of parameter(s) for the water delivered through the discharge outlet 24 of the electronic plumbing system 10 and a mechanism to deliver to the user the desired value(s) of the parameter(s) via the water delivered through the discharge outlet 24 of the electronic plumbing system 10. Exemplary parameters include a valve state (e.g., open or closed), a temperature, a flow rate, a volume, a spray pattern, a droplet size, a pulsation, and a duration. Additionally, in exemplary embodiments, the user input/output module 44 includes a mechanism (e.g., the activation sensor/display assembly 38 and, more specifically, the activation display 38b) to display to the user information regarding value(s) of parameter(s) for the water delivered through the discharge outlet 24 of the electronic plumbing system 10. Exemplary information includes an indication of value(s) of the parameter(s) for the water delivered through the discharge outlet 24 of the electronic plumbing system 10.

As stated above, in exemplary embodiments, the user input/output module 44 includes the activation sensor/display assembly 38 and, more specifically, the activation sensor 38a. In exemplary embodiments, the activation sensor/display assembly 38 includes a single activation sensor 38a. In exemplary embodiments, the activation sensor/display assembly 38 includes a plurality of activation sensors 38a. In exemplary embodiments including the plurality of activation sensors 38a, the activation sensors 38a are in a single location. In exemplary embodiments including the plurality of activation sensors 38a, the activations sensors 38a are in a plurality of locations. Exemplary locations for the activation sensor(s) 38a are illustrated in FIGS. 3a-1-3a-3, 3b-1-3b-3, and 6.

Additionally, as stated above, the activation sensor 38a defines the activation zone. In exemplary embodiments, the activation sensor 38a is operable to detect gestures of the object in the activation zone. In exemplary embodiments, each gesture of the object in the activation zone corresponds to value(s) of parameter(s) for the water delivered through the discharge outlet 24 of the electronic plumbing system 10. As the object (e.g., a hand) moves in the activation zone, the activation sensor 38a detects the gesture(s) of the object in the activation zone, and the desired value(s) of the parameter(s) for the water delivered through the discharge outlet 24 of the electronic plumbing system 10 are set to the value(s) corresponding to the detected gesture(s) of the object in the activation zone. Thus, in exemplary embodiments, each discrete gesture of the object in the activation zone corresponds to discrete value(s) of parameter(s) for the water.

Further, as stated above, in exemplary embodiments, as the object moves in the activation zone, the activation sensor 38a detects the gesture(s) of the object in the activation zone. In exemplary embodiments, each gesture of the object in the activation zone includes movement(s) and/or motion(s) of the object in the activation zone. In exemplary embodiments, the gestures of the object in the activation zone include linear movement(s) and/or motion(s) and/or rotational movement(s) and/or motion(s) of the object in the activation zone. In exemplary embodiments, the gestures of the object in the activation zone include linear movement(s) and/or motion(s) of the object in an x direction (i.e., along an x axis), in a y direction (i.e., along a y axis), and/or in a z direction (i.e., along a z axis) and/or rotational movement(s) and/or motion(s) of the object about the x axis, the y axis, and/or the z axis. In exemplary embodiments, the gestures of the object in the activation zone include a direction of movement and/or motion of the object in the activation zone and/or relative to the activation sensor 38a.

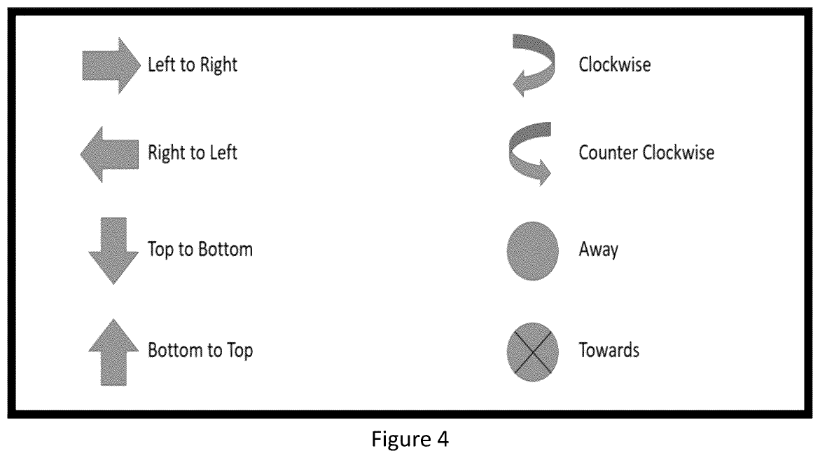

In exemplary embodiments, as best shown in FIG. 4, the gestures of the object in the activation zone include any one or more of the following movement(s) and/or motion(s) of the object in the activation zone and/or relative to the activation sensor 38a: (1) from left to right or move right, (2) from right to left or move left, (3) from top to bottom or move down, (4) from bottom to top or move up, (5) clockwise or circle-clockwise, (6) counter clockwise or circle-counter clockwise, (7) away or move backward, and (8) towards or move forward.

In exemplary embodiments, each gesture of the object in the activation zone corresponds to value(s) of parameter(s) for the water delivered through the discharge outlet 24 of the electronic plumbing system 10. In exemplary embodiments, a combination of gestures of the object in the activation zone corresponds to value(s) of parameter(s) for the water delivered through the discharge outlet 24 of the electronic plumbing system 10.

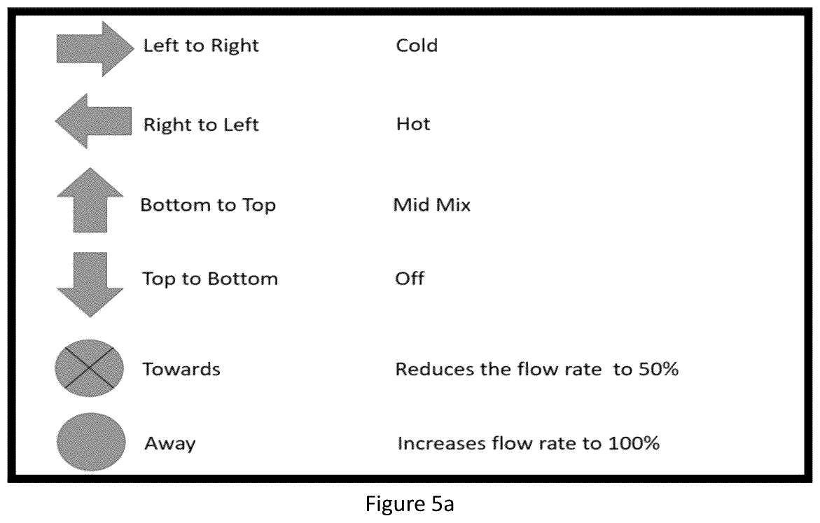

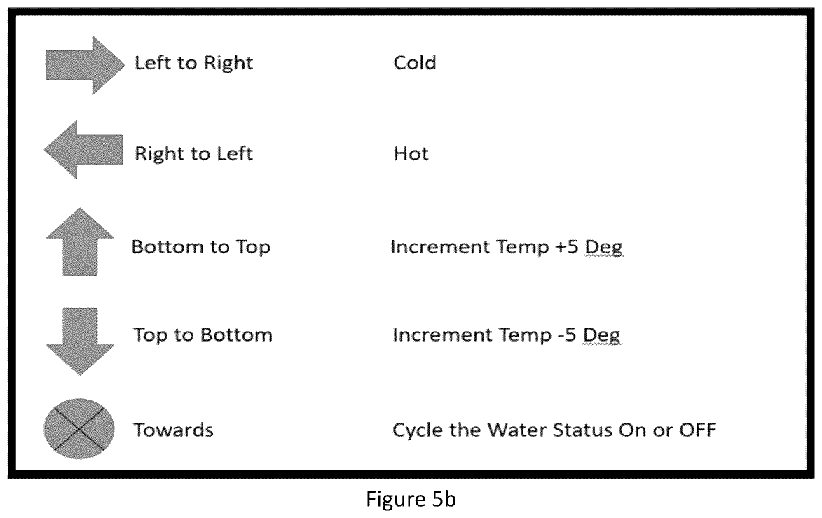

In exemplary embodiments, as best shown in FIG. 5a, the following is the correspondence of the gestures of the object in the activation zone to the values of the parameters for the water: (1) from left to right corresponds to cold water, (2) from right to left corresponds to hot water, (3) from bottom to top corresponds to mid mix temperature water, (4) from top to bottom corresponds to faucet off, (5) towards corresponds to reducing the flow rate to 50% of full flow, and (6) away corresponds to increasing the flow rate to 100% of full flow.

In exemplary embodiments, as best shown in FIG. 5b, the following is the correspondence of the gestures of the object in the activation zone to the values of the parameters for the water: (1) from left to right corresponds to cold water, (2) from right to left corresponds to hot water, (3) from bottom to top corresponds to increasing the temperature of the water by 5° F., (4) from top to bottom corresponds to decreasing the temperature of the water by 5° F., (5) towards corresponds to turning the water on if the water is currently off or turning the water off if the water is currently on.

In exemplary embodiments, as best shown in FIG. 5c, the following is the correspondence of the gestures of the object in the activation zone to the values of the parameters for the water: (1) from left to right corresponds to cold water, (2) from right to left corresponds to hot water, (3) from bottom to top corresponds to mid mix temperature water, and (4) from top to bottom corresponds to turning the water off.

In exemplary embodiments, as best shown in FIG. 6, the following is the correspondence of the gestures of the object in the activation zone to the values of the parameters for the water: (1) from left to right corresponds to hot water, (2) from front to back corresponds to warm water, (3) from left to right corresponds to cold water, (4) from back to front corresponds to turning the water off, and (5) in and out corresponds to turning the water on if the water is currently off and turning the water off if the water is currently on.

Exemplary embodiments of the gestures have been described above as including specific movement(s) and/or motion(s) of the object in the activation zone. However, one of ordinary skill in the art will appreciate that other exemplary embodiments of the gestures could include other movement(s) and/or motion(s) of the object in the activation zone. For example, other exemplary embodiments of the gestures could include waving a hand, raising a single finger, raising multiple fingers, and/or making a fist.

Similarly, exemplary embodiments of the gestures and the corresponding values of the parameters for the water have been described above as including specific gestures and corresponding values of the parameters for the water. However, one of ordinary skill in the art will appreciate that other exemplary embodiments of the gestures and the corresponding values of the parameters for the water could include other gestures and corresponding values of the parameters for the water.

In exemplary embodiments, each gesture and the corresponding value(s) of the parameter(s) for the water are stored in a lookup table or similar data structure. Similarly, in exemplary embodiments, each combination of gestures and the corresponding value(s) of the parameter(s) for the water are stored in a lookup table or similar data structure.

In exemplary embodiments, the data in the lookup table (i.e., the gestures and the corresponding values of the parameters for the water) are predetermined and stored by the system provider (such as the electronic plumbing system manufacturer). In exemplary embodiments, the data in the lookup table (i.e., the gestures and the corresponding values of the parameters for the water) are customizable and updatable by the user. In exemplary embodiments, the values of the parameters for the water corresponding to the gestures are customizable and updatable by the user. For example, if from left to right corresponds to “cold” and from right to left corresponds to “hot,” the user can specify a temperature of water that is “cold” (e.g., a coldest temperature available or 60° F.) and a temperature of water that is “hot” (e.g., a hottest temperature available or 110° F.). In exemplary embodiments, the parameters for the water corresponding to the gestures are customizable and updatable by the user. For example, if initially from left to right corresponds to “cold” and from right to left corresponds to “hot,” the user can instead specify that from left to right corresponds to “hot” and from right to left corresponds to “cold.”

Additionally, in exemplary embodiments, as best shown in FIG. 6, the user input/output module 44 (e.g., the mobile device 66) enables the user to input desired values of the temperature of water delivered through the discharge outlet 24 of the electronic plumbing system 10 for gestures for “hot,” “warm,” and “cold.” In the illustrated embodiment, the user input that “hot” means the hottest temperature available, “warm” means 105° F., and “cold” means the coldest temperature available. Once the user inputs the desired values, the user input/output module 44 displays the desired values to the user.

In exemplary embodiments, the temperature of the water may vary from a highest achievable temperature (e.g., 120° F.) to a lowest achievable temperature (e.g., 50° F.). In exemplary embodiments, the flow rate may vary from a full flow rate (i.e., 100% flow) to a minimal flow rate (i.e., 10% flow). In exemplary embodiments, the volume may vary from a high volume (e.g., one gallon) to a low volume (e.g., one teaspoon). However, one of ordinary skill in the art will appreciate that the values of the parameters for the water may have any range.

In exemplary embodiments, the temperature of the water may be varied at defined intervals (e.g., 5° F. increments or 5° F. decrements). In exemplary embodiments, the flow rate may be varied at defined intervals (e.g., 5% increments or 5% decrements). In exemplary embodiments, the volume may be varied at defined intervals (e.g., one quart or one-quarter teaspoon). However, one of ordinary skill in the art will appreciate that the values of the parameters for the water may be varied at any interval.

In exemplary embodiments, the activation sensor 38a includes an emitter and a plurality of detectors. In exemplary embodiments, the activation sensor 38a includes a plurality of emitters and a plurality of detectors. Each emitter is operable to emit energy (e.g., light or sound). Each detector is operable to detect the emitted energy. In exemplary embodiments, the activation sensor 38a is a proximity sensor. Proximity sensors are sensors that detect the presence of an object without any physical contact. In exemplary embodiments, the activation sensor 38a is an infrared (IR) sensor. However, one of ordinary skill in the art will appreciate that the activation sensor 38a could be any type of electronic sensor that can detect gestures of an object. Other exemplary sensors include, but are not limited to, radio frequency (RF) sensors, lidar sensors, radar sensors, time of flight (TOF) sensors, optical sensors, camera sensors, and capacitive sensors. In exemplary embodiments, the activation sensor 38a is a PAJ7620U2 integrated gesture recognition sensor, sold by PixArt Imaging Inc., as described in the PAJ7620U2 General Datasheet, version 1.0, dated Mar. 29, 2016, document number 41002AEN, and available for download at https://www.pixart.com/products-detail/37/PAJ7620U2.

As stated above, in exemplary embodiments, the user input/output module 44 includes the activation sensor/display assembly 38 and, more specifically, the activation display 38b. In exemplary embodiments, the activation sensor/display assembly 38 includes a single activation display 38b. In exemplary embodiments, the activation sensor/display assembly 38 includes a plurality of activation displays 38b. In exemplary embodiments including the plurality of activation displays 38b, the activation displays 38b are in a single location. In exemplary embodiments including the plurality of activation displays 38b, the activation displays 38b are in a plurality of locations. Exemplary locations for the activation display(s) 38b are illustrated in FIGS. 3a-1-3a-3, 3b-1-3b-3, and 6.

Additionally, as stated above, in exemplary embodiments, the activation display 38b is operable to convey to the user information regarding the value(s) of the parameter(s) for the water delivered through the discharge outlet 24 of the electronic plumbing system 10.

In exemplary embodiments, the activation display 38b is operable to provide visual feedback. In exemplary embodiments, the activation display 38b includes a light emitting diode (“LED”). In exemplary embodiments, the LED displays different colors and/or different flashing patterns. In exemplary embodiments, a short flashing pattern is in the range of approximately 0.1 second to 0.5 second, and a long flashing pattern is greater than approximately 0.5 second. For example, the LED of the activation display 38b could display a short flashing pattern when the system is activated and a long or no flashing pattern when the system state is deactivated. In exemplary embodiments, the activation display 38b includes a screen. In exemplary embodiments, the screen displays at least one of symbols, numbers, and characters.

In exemplary embodiments, the activation display 38b is operable to provide audible feedback. In exemplary embodiments, the activation display 38b includes a voice. In exemplary embodiments, the activation display 38b includes a beep or a tone. For example, the activation display 38b could make a beep or a tone when a desired temperature is reached. Similarly, the activation display 38b could make a beep or a tone when the system is activated or deactivated. In exemplary embodiments, the activation display 38b is operable to provide haptic feedback.

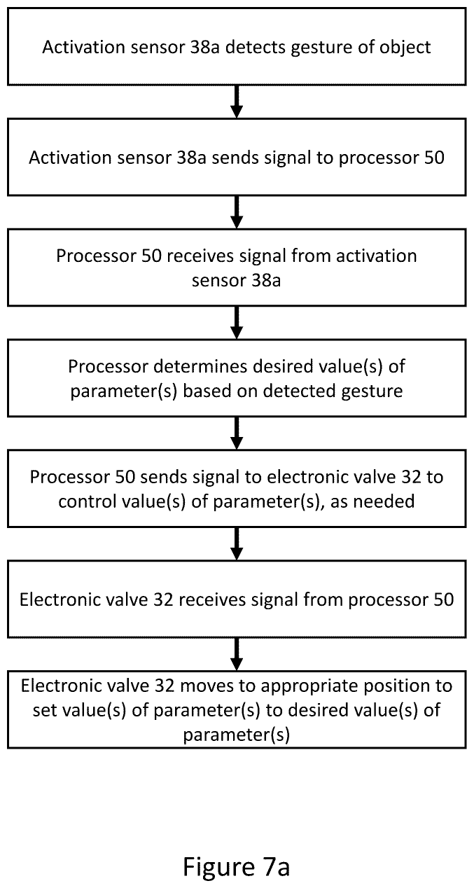

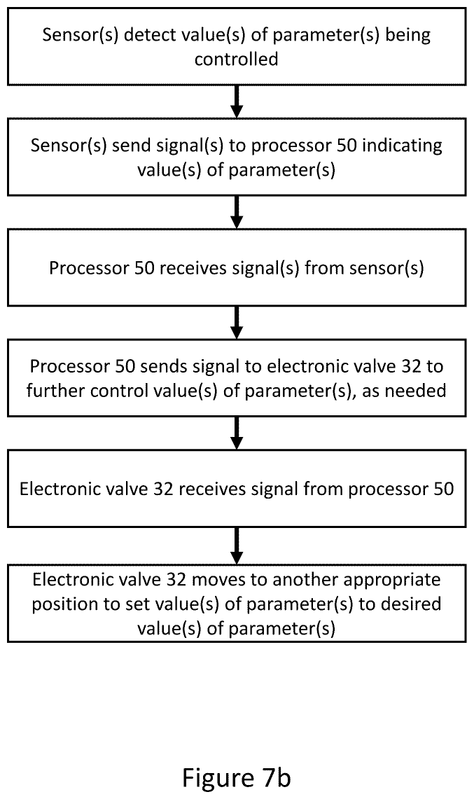

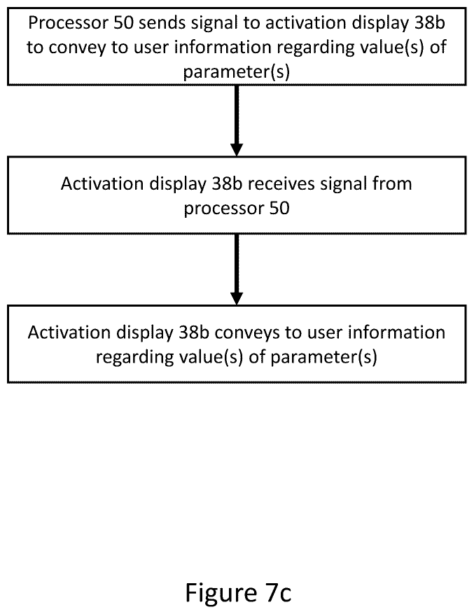

In exemplary embodiments, during operation of the electronic plumbing system 10, once the activation sensor 38a detects a gesture of the object in the activation zone, the activation sensor 38a sends a signal to the processor 50 indicating the detected gesture of the object in the activation zone. The processor 50 receives the signal from the activation sensor 38a and determines the desired value(s) of the parameter(s) for the water delivered through the discharge outlet 24 of the electronic plumbing system 10 based on the detected gesture of the object in the activation zone (e.g., using the lookup table or similar data structure). The processor 50 sends a signal to the electronic valve 32 to control the value(s) of the parameter(s) (i.e., to set the value(s) of the parameter(s) to the desired value(s) of the parameter(s)), as needed. The electronic valve 32 receives the signal from the processor 50 and moves to an appropriate position to set the value(s) of the parameter(s) to the desired value(s) of the parameter(s). Exemplary positions include a cracked open position, a closed position, or any position between the cracked open position and the closed position to achieve the desired value(s) of the parameter(s) (e.g., the desired valve state, temperature, flow rate, volume, and/or spray pattern of water). These exemplary steps are illustrated in FIG. 7a. These steps are repeated each time the activation sensor 38a detects a gesture of the object in the activation zone.

Depending on the parameter(s) being controlled, the sensor(s) (e.g., the temperature sensor 74, the flow sensor 76, the pressure sensor 78, and/or the valve sensor 80) detect the value(s) of the parameter(s) being controlled and send signal(s) to the processor 50 indicating the detected value(s) of the parameter(s). The processor 50 receives the signal(s) from the sensor(s) (e.g., the temperature sensor 74, the flow sensor 76, the pressure sensor 78, and/or the valve sensor 80) and sends a signal to the electronic valve 32 to further control the current value(s) of the parameter(s) (i.e., to set the value(s) of the parameter(s) to the desired value(s) of the parameter(s)), as needed. The electronic valve 32 receives the signal from the processor 50 and moves to another appropriate position to set the value(s) of the parameter(s) to the desired value(s) of the parameter(s). These exemplary steps are illustrated in FIG. 7b. These steps are repeated until the value(s) of the parameter(s) are set to the desired value(s) of the parameter(s).

Moreover, the processor 50 sends a signal to the activation display 38b to convey to the user information regarding the value(s) of the parameter(s) for the water delivered through the discharge outlet 24 of the electronic plumbing system 10 (e.g., the indication of the value(s) of the parameter(s) delivered through the discharge outlet 24 of the electronic plumbing system 10). The activation display 38b receives the signal from the processor 50 and conveys to the user the information regarding the value(s) of the parameter(s). These exemplary steps are illustrated in FIG. 7c. These steps are repeated each time there is information for the activation display 38b to convey to the user.

In the exemplary embodiments described above, the signals received from and sent to the components of the electronic plumbing system 10 (e.g., the activation sensor 38a, other sensors, the activation display 38b, and the electronic valve 32) to control the operation of the electronic plumbing system 10 are received from and sent to the processor 50 in the control module 42. However, as stated above, one of ordinary skill in the art will appreciate that the signals received from and sent to the components of the electronic plumbing system 10 (e.g., the activation sensor 38a, other sensors, the activation display 38b, and the electronic valve 32) can be received from and sent to the processor 58a in the system provider cloud server 58 and/or the processor 60a in the third party cloud server 60 in addition to or alternatively to the processor 50 in the control module 42.

The following includes definitions of exemplary terms that may be used throughout the disclosure. Both singular and plural forms of all terms fall within each meaning.

“Computer” or “processor,” as used herein includes, but is not limited to, one or more programmed or programmable electronic device or coordinated devices that can store, retrieve, or process data and may be any processing unit, distributed processing configuration, or processor systems. Examples of processor include microprocessors, microcontrollers, central processing units (CPUs), graphics processing units (GPUs), tensor processing unit (TPU), floating point units (FPUs), reduced instruction set computing (RISC) processors, digital signal processors (DSPs), field programmable gate arrays (FPGAs), etc., in any combination. One or more cores of a single microprocessor and/or multiple microprocessor each having one or more cores can be used to perform the operation as being executed by a processor herein. The processor can also be a processor dedicated to the training of neural networks and other artificial intelligence (AI) systems. The processor may be associated with various other circuits that support operation in the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or drawings.

“Network interface,” synonymous with “data interface,” as used herein includes, but is not limited to, any interface or protocol for transmitting and receiving data between electronic devices. The network or data interface can refer to a connection to a computer via a local network or through the internet and can also refer to a connection to a portable device—e.g., a mobile device or a USB thumb drive—via a wired or wireless connection. A network interface can be used to form networks of computers to facilitate distributed and/or remote computing (i.e., cloud-based computing). “Cloud-based computing” means computing that is implemented on a network of computing devices that are remotely connected to the device via a network interface.

“Signal,” as used herein includes, but is not limited to, one or more electric signals, including analog or digital signals, one or more computer instructions, a bit or bit stream, or the like.

“Logic,” synonymous with “circuit,” as used herein includes but is not limited to hardware, firmware, software and/or combinations of each to perform a function(s) or action(s). For example, based on a desired application or needs, logic may include a software-controlled microprocessor, discrete logic such as an application specific integrated circuit (ASIC), or other programmed logic device and/or controller. Logic may also be fully embodied as software. The logic flow of an embodiment of the invention could be embodied in logic.

“Software,” as used herein includes, but is not limited to, one or more computer readable and/or executable instructions that cause a computer, processor, logic, and/or other electronic device to perform functions, actions, and/or behave in a desired manner. The instruments may be embodied in various forms such as routines, algorithms, modules, or programs including separate applications or code from dynamically linked sources or libraries (DLLs). Software may also be implemented in various forms such as a stand-alone program, a web-based program, a function call, a subroutine, a servlet, an application, an app, an applet (e.g., a Java applet), a plug-in, instructions stored in a memory, part of an operating system, or other type of executable instructions or interpreted instructions from which executable instructions are created. The logic flow of an embodiment of the invention could be embodied in software.

“Module” or “engine” as used herein will be appreciated as comprising various configurations of computer hardware and/or software implemented to perform operations. In some embodiments, modules or engines as described herein may be represented as instructions operable to be executed by a processor in a processor or memory. In other embodiments, modules or engines as described herein may be represented as instructions read or executed from readable media. A module or engine may operate in either hardware or software according to application specific parameters or user settings. It will be appreciated by those of skill in the art that such configurations of hardware and software may vary, but remain operable in substantially similar ways. The logic flow of an embodiment of the invention could be embodied in a module or engine.

“Data storage device,” as used herein includes, but is not limited to, a device or devices for non-transitory storage of code or data, e.g., a device with a non-transitory computer readable medium. As used herein, “non-transitory computer readable medium” mean any suitable non-transitory computer readable medium for storing code or data, such as a magnetic medium, e.g., fixed disks in external hard drives, fixed disks in internal hard drives, and flexible disks; an optical medium, e.g., CD disk, DVD disk; and other media, e.g., ROM, PROM, EPROM, EEPROM, flash PROM, external memory drives, etc. The memory of an embodiment of the invention could be embodied in a data storage device.

While the above exemplary definitions have been provided, it is intended that the broadest reasonable interpretation consistent with this specification be used for these and other terms. Aspects and implementations of the present disclosure will be understood more fully from the detailed description given below and from the accompanying drawings of the various aspects and implementations of the disclosure. This should not be taken to limit the disclosure to the specific aspects or implementations, but is for explanation and understanding only.

One of ordinary skill in the art will now appreciate that the present invention provides an electronic plumbing system including gesture control. Although the present invention has been shown and described with reference to particular embodiments, equivalent alterations and modifications will occur to those skilled in the art upon reading and understanding this specification. The present invention includes all such equivalent alterations and modifications and is limited only by the scope of the following claims in light of their full scope of equivalents.

What is claimed is:

1. A system, comprising:
a body, the body operable to be mounted on a surface, the body including a discharge outlet, the discharge outlet operable to deliver water;
an electronic valve, the electronic valve operable to permit flow of water through the discharge outlet when the electronic valve is activated and to not permit flow of water through the discharge outlet when the electronic valve is deactivated, the electronic valve operable to control a parameter for water flowing through the discharge outlet;
a user input/output module, the user input/output module operable to communicate with a user regarding a desired value of the parameter for water, the user input/output module including a single activation sensor, the activation sensor operable to be mounted on the body, the activation sensor operable to define an activation zone, the activation sensor operable to detect a gesture of an object in the activation zone, each gesture corresponding to a desired value of the parameter for water; and
a processor, the processor operable to communicate with each of the electronic valve and the user input/output module regarding the desired value of the parameter for water;
wherein the activation sensor is operable to detect a gesture of an object in the activation zone and to send a signal to the processor indicating the detected gesture of the object in the activation zone;
wherein the processor is operable to receive the signal from the activation sensor and to send a signal to the electronic valve to flow the desired value of the parameter for water corresponding to the detected gesture of the object in the activation zone; and
wherein the electronic valve is operable to receive the signal from the processor and to flow the desired value of the parameter for water.

2. The system of claim 1, wherein the user input/output module further includes a mobile device.

3. The system of claim 1, wherein the user input/output module further includes a voice controlled device.

4. The system of claim 1, wherein the user input/output module further includes a mobile device and a voice controlled device.

5. The system of claim 1, wherein the processor includes a processor in a control module.

6. The system of claim 1, wherein the processor includes a processor in a cloud server.

7. The system of claim 1, wherein the processor includes a processor in a control module and a processor in a cloud server.
